(19) United States
(12) Patent Application Publication
(10) Pub. No.: US 2023/0247672 A1
(43) Pub. Date: Aug. 3, 2023

(54) RANDOM ACCESS REPORT IN MIXED NETWORK TYPES

(71) Applicant: NOKIA TECHNOLOGIES OY, Espoo (FI)

(72) Inventors: Anna Pantelidou, Massy (FR); Malgorzata Tomala, Wroclaw (PL)

(21) Appl. No.: 18/002,929

(22) PCT Filed: Jun. 22, 2020
(86) PCT No.: PCT/EP2020/067336

§ 371 Date: Dec. 22, 2022

(51) Int. Cl. H04W 74/08

(52) U.S. Cl. CPC H04W 74/0833

(57) ABSTRACT

A method, apparatus, and a computer-readable storage medium are provided for random access reporting in mixed network types. In an example implementation, the method may include detecting, by a user equipment, random access to at least one or more public and/or one or more non-public networks; and generating, by the user equipment, one or more random access reports, the one or more random access reports including network identifying information related to random access failures associated with the at least one or more public and/or one or more non-public networks. In another example implementation, the method may include transmitting, by a network node to a user equipment, a request for one or more random access reports generated at the user equipment; and receiving, by the network node, in response to the request, the one or more random access reports from the user equipment, the one or more random access reports including network identifying information related to random access failures associated with the at

### TECHNICAL FIELD

This description relates to wireless communications, and in particular, random access reporting.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP’s Long Term Evolution (LTE) upgrade path for mobile networks. In LTE, base stations or access points (APs), which are referred to as enhanced Node AP or Evolved Node B (eNBs), provide wireless access within a coverage area or cell. In LTE, mobile devices, or mobile stations are referred to as user equipments (UE). LTE has included a number of improvements or developments.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT), and may offer new types of mission-critical services. Ultra-reliable and low-latency communications (URLLC) devices may require high reliability and very low latency.

### SUMMARY

Various example implementations are described and/or illustrated. The details of one or more examples of implementations are set forth in the accompanying drawings and the description below. Other features will be apparent from the description and drawings, and from the claims.

A method, apparatus, and a computer-readable storage medium are provided for random access reporting in mixed network types. In an example implementation, the method may include detecting, by a user equipment, random access to at least one or more public and/or one or more non-public networks; and generating, by the user equipment, one or more random access reports, the one or more random access reports including network identifying information related to random access failures associated with the at least one or more public and/or one or more non-public networks. In another example implementation, the method may include transmitting, by a network node to a user equipment, a request for one or more random access reports generated at the user equipment; and receiving, by the network node, in response to the request, the one or more random access reports from the user equipment, the one or more random access reports including network identifying information related to random access failures associated with the at least one or more public and/or one or more non-public networks.

### BRIEF DESCRIPTION OF THE DRAWINGS

FIG. 1 is a block diagram of a wireless network according to an example implementation.

FIGS. 2A and 2B illustrate problems associated with random access reporting in a mixed network type deployment.

FIGS. 3-4 illustrate random access reporting in a mixed network type deployment, according to various example implementations.

FIGS. 5-6 are flow charts illustrating random access reporting in a mixed network type deployment, according to various example implementations.

FIG. 7 is a block diagram of a node or wireless station (e.g., base station/access point or mobile station/user device/UE), according to an example implementation.

### DETAILED DESCRIPTION

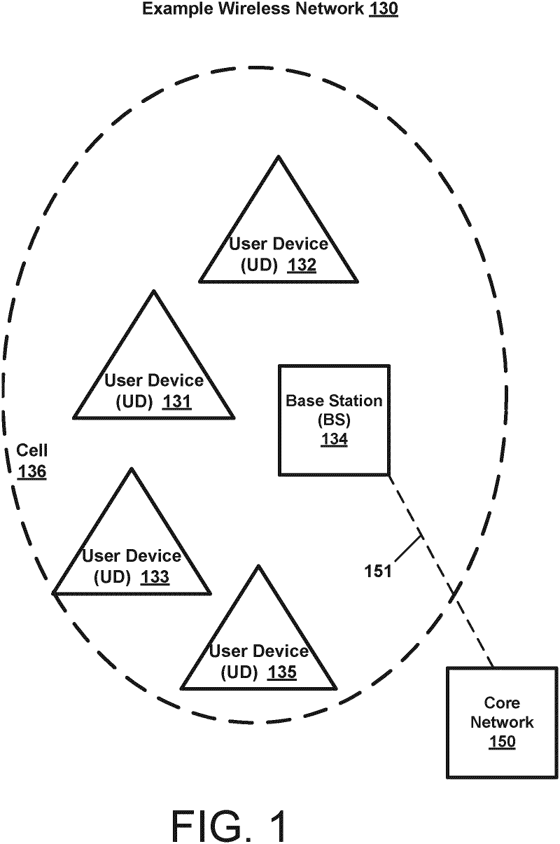

FIG. 1 is a block diagram of a wireless network 130 according to an example implementation. In the wireless network 130 of FIG. 1, user devices (UDs) 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a next-generation Node B (gNB) or a network node. At least part of the functionalities of an access point (AP), base station (BS), (e)Node B (eNB), or gNB may also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples, or any other wireless device. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example implementations or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC).

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC or machine to machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing up to e.g., 1 ms U-Plane (user/data plane) latency connectivity with 1-1e-5 reliability, by way of an illustrative example. Thus, for example, URLLC user devices/UEs may require a significantly lower block error rate than other types of user devices/UEs as well as low latency. Thus, for example, a URLLC UE (or URLLC application on a UE) may require much shorter latency, as compared to an eMBB UE (or an eMBB application running on a UE).

The various example implementations may be applied to a wide variety of wireless technologies or wireless networks, such as LTE, LTE-A, 5G, IoT, MTC, eMTC, eMBB, URLLC, etc., or any other wireless network or wireless technology. These example networks, technologies or data service types are provided only as illustrative examples.

Multiple Input, Multiple Output (MIMO) may refer to a technique for increasing the capacity of a radio link using multiple transmit and receive antennas to exploit multipath propagation. MIMO may include the use of multiple antennas at the transmitter and/or the receiver. MIMO may include a multi-dimensional approach that transmits and receives two or more unique data streams through one radio channel. For example, MIMO may refer to a technique for sending and receiving more than one data signal simultaneously over the same radio channel by exploiting multipath propagation. According to an illustrative example, multi-user multiple input, multiple output (multi-user MIMO, or MU-MIMO) enhances MIMO technology by allowing a base station (BS) or other wireless node to simultaneously transmit or receive multiple streams to different user devices or UEs, which may include simultaneously transmitting a first stream to a first UE, and a second stream to a second UE, via a same (or common or shared) set of physical resource blocks (PRBs) (e.g., where each PRB may include a set of time-frequency resources).

Also, a BS may use precoding to transmit data to a UE (based on a precoder matrix or precoder vector for the UE). For example, a UE may receive reference signals or pilot signals, and may determine a quantized version of a DL channel estimate, and then provide the BS with an indication of the quantized DL channel estimate. The BS may determine a precoder matrix based on the quantized channel estimate, where the precoder matrix may be used to focus or direct transmitted signal energy in the best channel direction for the UE. Also, each UE may e.g., where the UE may receive reference signals from the BS, determine a channel estimate of the DL channel, and then determine a decoder matrix for the DL channel based on the DL channel estimate. For example, a precoder matrix may indicate antenna weights (e.g., an amplitude/gain and phase for each weight) to be applied to an antenna array of a transmitting wireless device. Likewise, a decoder matrix may indicate antenna weights (e.g., an amplitude/gain and phase for each weight) to be applied to an antenna array of a receiving wireless device. This applies to UL as well when a UE is transmitting data to a BS.

For example, according to an example aspect, a receiving wireless user device may determine a precoder matrix using Interference Rejection Combining (IRC) in which the user device may receive reference signals (or other signals) from a number of BSs (e.g., and may measure a signal strength, signal power, or other signal parameter for a signal received from each BS), and may generate a decoder matrix that may suppress or reduce signals from one or more interferers (or interfering cells or BSs), e.g., by providing a null (or very low antenna gain) in the direction of the interfering signal, in order to increase a signal-to interference plus noise ratio (SINR) of a desired signal. In order to reduce the overall interference from a number of different interferers, a receiver may use, for example, a Linear Minimum Mean Square Error Interference Rejection Combining (LMMSE-IRC) receiver to determine a decoding matrix. The IRC receiver and LMMSE-IRC receiver are merely examples, and other types of receivers or techniques may be used to determine a decoder matrix. After the decoder matrix has been determined, the receiving UE/user device may apply antenna weights (e.g., each antenna weight including amplitude and phase) to a plurality of antennas at the receiving UE or device based on the decoder matrix. Similarly, a precoder matrix may include antenna weights that may be applied to antennas of a transmitting wireless device or node. This applies to a receiving BS as well.

There are two types of non-public networks (NPNs), stand-alone NPNs (SNPNs) and public network integrated NPNs (PNI-NPNs). A SNPN is generally operated by an NPN operator and does not rely on an underlying public land mobile network (PLMN). A PNI-NPN is a network deployed for non-public use and relies on some network functions provided by a PLMN. In PNI-NPNs, a closed access group (CAG) identifies a group of subscribers that are permitted to access one or more CAG cells associated with the CAG. A CAG is identified by a CAG identifier that is broadcasted via a system information block (e.g., SIB1). A UE can be configured with, for example, a CAG list (that includes CAG identifiers), the UE is allowed to access and a CAG-only indication if the UE is only allowed to access 5GS via CAG cells. The configuration can be per PLMN. In other words, a CAG ID uniquely identifies a CAG in a PLMN and the PLMN that supports the CAG sends a CAG indication identifying a CAG cell. It should be noted that different gNBs can support different sets of CAG IDs.

As part of 3GPP RAN work item related to NPNs in 5G, it was agreed in RP 19-190729 that PNI-NPNs would be supported and the requirements to support PNI-NPNs were specified at a high level by SA2 in TS 23.501. These requirements indicate that a UE can be associated with a “list of UE Allowed CAG IDs,” closed access group identifiers identifying the closed access groups to which the UE belongs. A CAG cell in a next generation radio access network (NG-RAN) can support one or more CAG IDs. A UE is authorized to access a cell of the PLMN if at least one of the UE allowed CAG IDs is supported in the cell.

In order for a NG-RAN node to determine that a UE is allowed to access a cell in connected mode mobility, or to enable the NG-RAN to select suitable cells for the UE in connected mode mobility, the NG-RAN node needs to be aware of the list of UE Allowed CAG IDs. An access management function (AMF) provides the list of UE Allowed CAG IDs to the NG-RAN node which is then sent using next generation application protocol (NGAP) messages creating a context for the UE in the NG-RAN node (e.g., initial context setup).

A cell-id (or identifier) is included in a UE random access report. However, the existence of mixed network deployments is currently not taken into consideration in random access reporting by a UE. For instance, if a cell (or node) is shared, the network cannot determine (or distinguish), based on the cell-id in the random access report, whether the UE attempted random access on a PLMN, SNPN, or PNI-NPN node. Further, the network is not aware if the UE attempted random access on a CAG of a PNI-NPN and failed before attempting random access on the PLMN.

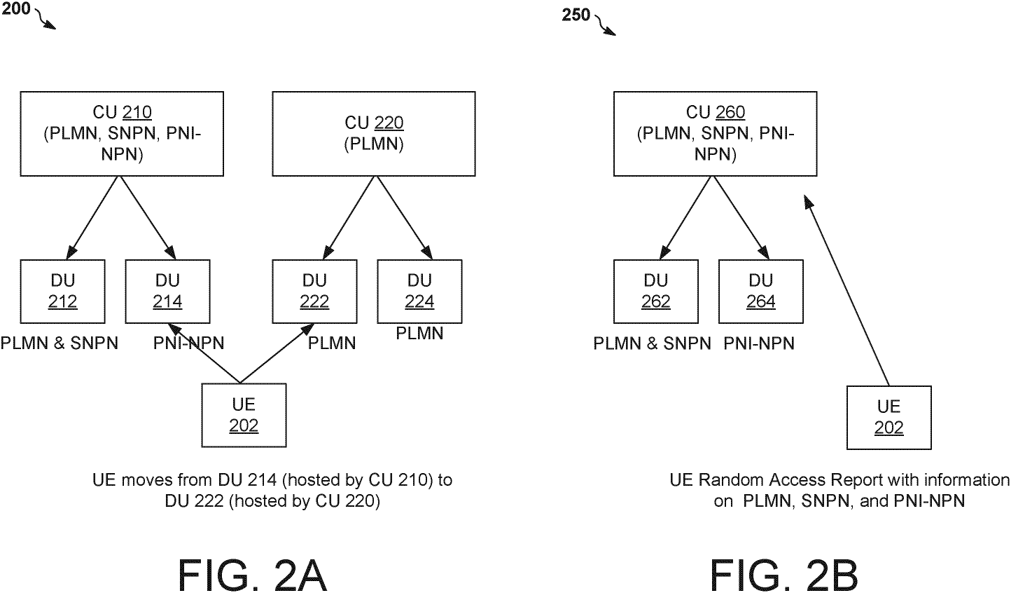

Furthermore, in split centralized unit (CU)/distributed unit (DU) architecture under NG-RAN sharing, the CU and DUs can be shared among different public and non-public networks. According to NG-RAN sharing, in an example scenario, a CU can support PLMN, SNPN, and/or PNI-NPN through its DUs, where a DU can support one or more of PLMN, SNPN, and PNI-NPNs as illustrated in FIGS. 2A and 2B.

In some scenarios, a UE, e.g., UE 202, connected to CU 210 via DU 214 that supports PNI-NPN may perform a random access procedure (e.g., during a beam failure recovery procedure) to access the PLMN at DU 222 of NG RAN node CU 220. Since a UE is allowed to log up to 8 random access procedures in a NR UE random access report, the UE may continue to log random access information while the UE is connected to CU 220. When CU 220 requests random access report from the UE, the UE should deliver the information and CU 220 should be able to distinguish that the random access information in the UE random access report also contains PNI-NPN random access information, which is not relevant for CU 220.

In addition, as illustrated in FIG. 2B, the UE is connected to a CU, e.g., CU 260 supporting all types of public (PLMN) and non-public (PNI-NPN and SNPN) networks and gNB-DUs (e.g., DUs 262 and 264) may/may not be shared. For example, in 250 of FIG. 2B, DU 262 may be shared between PLMN and SNPN, but DU 264 may not be shared and may support only PNI-NPN networks. When the UE sends a random access report to CU 260, the CU needs to be able to determine the DU to forward the random access report (for example, according to the agreement from RAN3 #106, the RACH configuration conflict detection and resolution function is located at gNB-DU and signaling of UE RACH reports to the gNB-DU is needed). Therefore, if CU 260 forwards the UE random access report to DU 264, DU 264 has no means to process this information as the information is not relevant for network types DU 264 supports. In addition, the information in the random access report which may include random accesses on PLMNs and SNPNs is not relevant for DU 264 which supports PNI-NPN network only and some signaling could be saved if CU 260 has means to filter that information, e.g., CU 260 could only forward PNI-NPN related random access information to DU 264. Therefore, the current network setup that is scattered across several network entities, each identified by a separate ID, is not feasible to be tracked by the existing UE random access report and is insufficient for mixed network types.

The present disclosure describes random access optimization on a network type basis. In some implementations, for example, the network type may be a public network type (e.g., a PLMN) or a non-public network type (e.g., a SNPN, a PNI-NPN, etc.). These are just example network types and the disclosure may apply to other network types as well. In addition, the disclosure also describes support for NPN based (e.g., CAG based or PLMN + NID based) random access reporting to NG-RAN nodes where the NG-RAN nodes may be shared with both public and non-public networks and the random access reporting information may be forwarded among NG-RAN nodes and from a gNB-CU to its gNB-DUs.

In some implementations, for example, support for mixed network types may be introduced by self-organizing network (SON) mechanisms for random access reporting optimization. In an example implementation, a UE may detect random access towards non-public and/or public networks and may perform random access reporting, e.g., reporting of random access failures, to a cell (or node) that may be associated with various networks types (e.g., mixed network type) such that the random access report includes identity of the public and/or non-public network types.

In an example implementation, a user equipment (UE) may detect random access to at least one or more public and/or one or more non-public networks and generate one or more random access reports. The one or more random access reports may include network identifying information related to random access failures associated with the at least one or more public and/or one or more non-public networks.

In another example implementation, a network node (e.g., gNB) may transmit a request for one or more random access reports generated at the user equipment and receive, in response to the request, the one or more random access reports from the user equipment. The one or more random access reports may include network identifying information related to random access failures associated with the at least one or more public and/or one or more non-public networks.

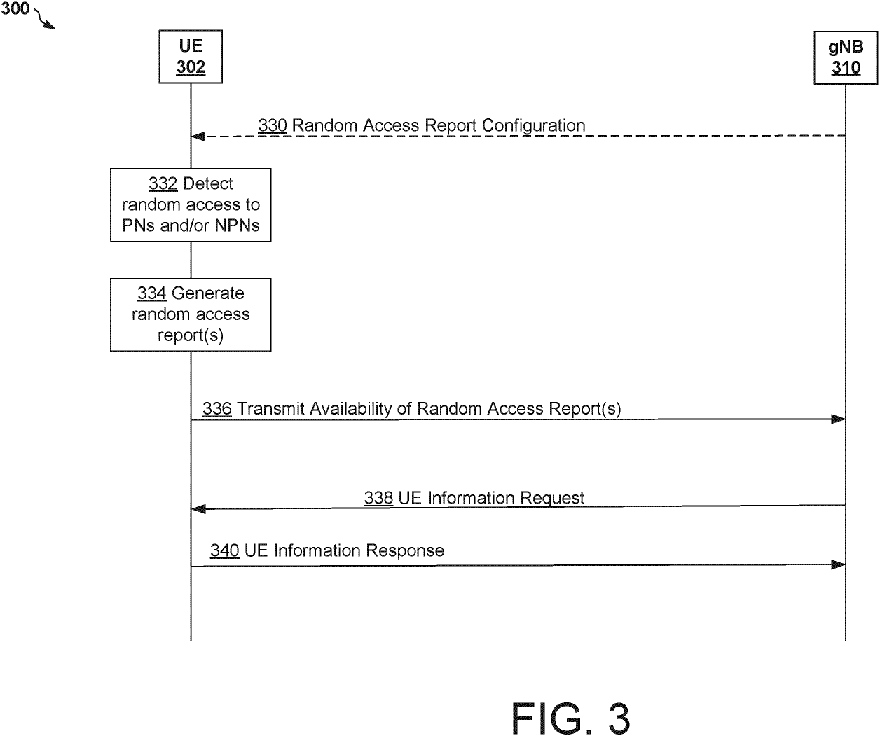

FIG. 3 illustrates random access reporting 300 in a mixed network type deployment, according to an example implementation. In an example implementation, FIG. 3 illustrates a user equipment, e.g., UE 302, which may be in communication with a network node, e.g., gNB (or cell) 310.

In some implementations, for example, UE 302 may create a random access report (e.g., also referred to as a random access channel (RACH) report in the present disclosure) in response to a random access attempt (or RACH attempt) not being successful (e.g., random access fails). That is, the UE may autonomously generate a random access report when a random access attempt fails at the UE. In addition, in some implementations, for example, UE 302 may create a random access report in response to any random access attempt, e.g., successful and unsuccessful. In other words, the UE may autonomously generate a random access report when a random access attempt is performed.

Optionally, at 330, in some implementations, for example, UE 302 may receive random access report configuration from gNB 310. In an example implementation, the random access report configuration may indicate to the UE the network types for which the UE should generate the random access reports. The network types indicated in the random access report configuration may include one or more of the following network types: PLMN, SNPN, and/or PNI-NPN. These are just example network types that may be indicated in the random access report configuration and other (and/or additional) network types may be configured as well. This may allow the gNB to configure the network types the gNB is interested in receiving from the UE. In some implementations, for example, the random access report configuration that may be forwarded from gNB 310 may have been received by the gNB from an operations, administration, and management (OA&M) entity.

At 332, UE 302 may detect that the UE is configured to initiate random access procedure(s) to a PLMN and/or an NPN. The UE may initiate the random access procedure based on the network types (or gNBs/cells) configured for the UE for performing random access procedure. In an example implementation, the UE may detect it based on the random access report configuration received from gNB 310. Once the UE detects that the UE is configured for generating a random access report for a network type (e.g., PLMN and/or NPN), the UE generates random access reports that indicate whether a random access failure is associated with the PLMN and/or the NPN. In some implementations, for example, the UE may be configured to generate separate reports for SNPN and PNI-NPN so that the network can differentiate between SNPN and PNI-NPN random access failures. In some implementations, for example, the UE may generate separate reports for SNPN and PNI-NPN so that the network can differentiate between SNPN and PNI-NPN random access failures. This may be performed with or without prior configuration from the network.

At 334, UE 302 may generate random access reports. In some implementations, for example, the random access reports may be generated when the UE encounters a random access failure. A random access failure may be defined as a failure of a random access attempt and may occur due to various reasons (e.g., poor RF conditions, mobility, incorrect settings, etc.). In some implementations, for example, the random access report may be generated in such a way that the gNB could differentiate whether a random access failure in a random access report is associated with a PLMN or NPN; PLMN, SNPN, or PNI-NPN, etc.

In an example implementation, UE 302 may generate different random access reports for different network types. For example, UE 302 may generate a first random access report for a PLMN and a second random access report for NPN (e.g., including SNPN and PNI-NPN). In an additional example implementation, UE 302 may generate a first random access report for a PLMN, a second random access report for SNPN, and/or a third random access report for PNI-NPN. The random access report may include network identifier(s) so that gNB 310 may determine whether a random access failure is associated with an identifier of the PLMN, SNPN, or PNI-NPN.

In an additional example implementation, UE 302 may generate a random access report that includes random access failures associated with all network types. In such an implementation, the random access report may include random access related instances (e.g., failures) with associated network identifiers which allows gNB 310 to distinguish among random access failures associated with each network type. In some implementations, for example, a flag may be used in the random access report to indicate a random access failure associated with NPN type or two flags (with different values) may be used to differentiate random access failures between PLMN and NPN; or among PLMN, SNPN, and PNI-NPN. Although this example implementation may be simple to implement, in split architecture (e.g., centralized unit (CU)/distributed unit (DU) architecture), the CU of a gNB may have to process the random access reports before forwarding the correct information to the DUs (or to other gNBs). In some implementations, for example, a cell id may be associated with a network identifier corresponding to a PLMN ID, SNPN ID, PNI-NPN ID, etc., depending on the network type on which the random access was attempted.

The generating of random access reports may include information (e.g., variables) which may be used by gNB 310 to differentiate among various network types for several purposes. In an example implementation, the UE may spend more time in one network type (e.g., a first network type) versus another network type (e.g., second network type) and the UE may experience a higher number of random access failures on the first network type (vs the second network type). This allows the gNB to detect that there may be a problem with random access procedures associated with the first network type. However, if there is no distinction among the network types in a random access report, the gNB may not be able to determine the specific network type with the higher rate of random access failures and may lead to lower network performance (e.g., higher access rate of failures, etc.). In an example implementation, CAG-based random access information may not be sufficiently logged in the random access report if the random access report is already full with public network information and the network hasn’t retrieved the random access report yet. In some implementations, this may also enable the network to retrieve random access reports with different timings and/or set the validity expiration timers with different time durations.

In addition, since a NG-RAN may be shared, in an example implementation, multiple PLMNs or SNPNs or PNI-NPNs may share a common NG-RAN node. In an additional example implementation, a NG-RAN may support only some of the network types (for example, PLMN and PNI-NPN but not SNPN) and the generation of separate random access reports for different network types may allow forwarding of only the relevant random access reports. In other words, a NG-RAN node may only forward the relevant random access reports to a neighbor node (e.g., via Xn interface). This may reduce unnecessary forwarding of random access reports in the network.

At 336, UE 302 may transmit a message (e.g., an availability indicator) indicating the availability of random access reports to gNB 310. In some implementations, for example, the UE may notify the gNB about the availability of the random access reports via the availability indicator. In addition, in some implementations, the availability indicator may indicate the network types for which the random access reports are available so that the gNB may request random access reports associated with the one or more network types.

At 338, in some implementations, for example, UE 302 may receive a request from gNB 310 for the random access reports. In some implementations, for example, the request may be received from the gNB via a user equipment information request message. The request from gNB 310 may try to retrieve random access reports for a certain network type. In some implementations, the UE may indicate to the gNB the availability of random access reports on a network type basis such that the gNB may request such information (e.g., better granularity), as needed. In some implementations, for example, the gNB may request the random access report via the UE Information Request based on, for example, the availability indicator, received from the UE. In addition, in some implementations, the gNB may request random access reports associated with one or more network types if such information is indicated in the availability indicator.

At 340, UE 302 may transmit the random access reports to gNB 310 in response to receiving the request from the gNB. In some implementations, for example, the UE may transmit the random access reports via a user equipment information response message to the gNB. In some implementations, for example, the UE may transmit the random access reports for the network types requested in the user equipment information request message received from the gNB.

Thus, the UE may transmit random access reports in mixed network type configurations where the gNB may distinguish among random access failures associated with public and/or non-public networks and which may be further used to optimize the network.

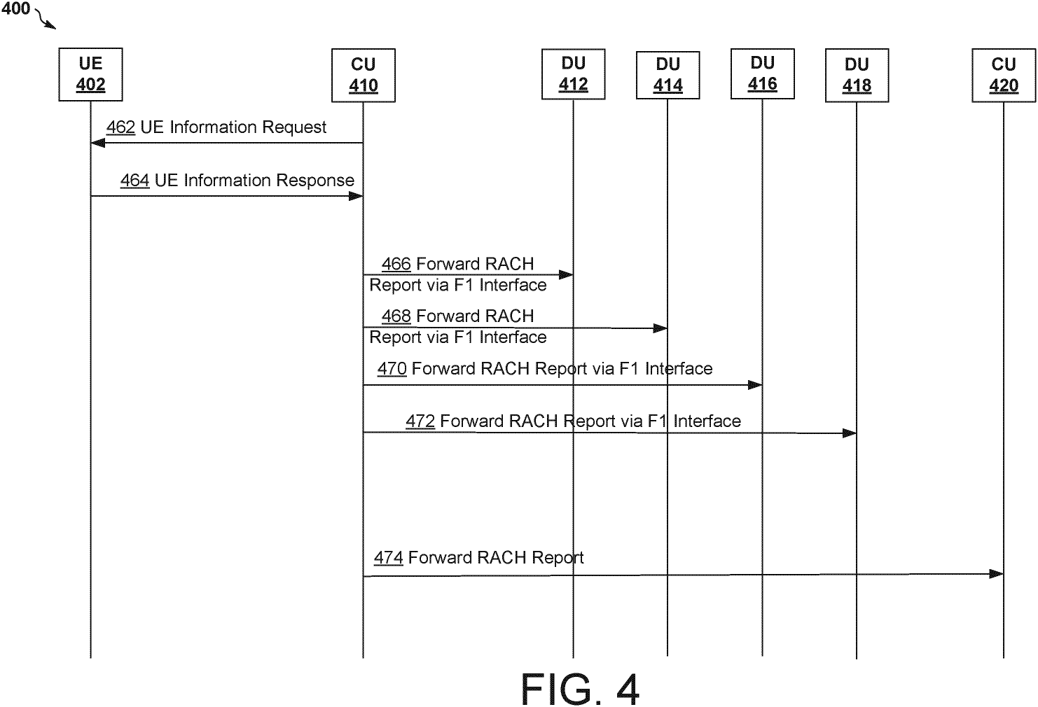

FIG. 4 illustrates random access reporting 400 in a mixed network deployment, according to an additional example implementation. In an example implementation, FIG. 4 illustrates a user equipment, e.g., UE 402 (which may be same as or similar to UE 302 of FIG. 3) and CUs 410 and 420. CU 410 may be associated with DUs 412, 414, 416, and/or 418. UE 402 may be in communication with CUs 410 and 420, which may be same as or similar to gNB 310 of FIG. 3.

In an example implementation, CU 410 may be configured to support PLMN, SNPN, and PNI-NPN and is configured to support DUs 412, 414, 416, and/or 418 in a split architecture. For example, DU 412 may be configured to support PLMN; DU 414 may be configured to support SNPN and PNI-NPN; DU 416 may be configured to support PNI-NPN; and DU 418 may be configured to support PLMN, SNPN, and PNI-NPN. In an additional example implementation, CU 420 may be configured to support PLMN, SNPN, and PNI-NPN. These are just example configurations and other (or additional) configurations may be supported as well.

In some implementations, for example, gNB DUs may be configured to support only NPNs (e.g., dedicated for NPNs) and such configuration allows for forwarding of random access reports on a network type basis so that only the relevant random access information from a gNB-CU (e.g., CU 410) is forwarded to a gNB-DU (e.g., DU 414). In an example implementation, the random access reporting information may be stored in containers and the CU may forward the relevant container (e.g., containing the relevant information) to a DU.

In an example implementation, at 462, a network node, e.g., CU 410 may send a UE information request message (e.g., UEInformationRequest message) to a UE, e.g., UE 402. The UE information procedure may be used by the network to request random access reports.

At 464, CU 410 may receive a UE information response message (e.g., UEInformationResponse message) from UE 402. In some implementations, the UE information response message may include the random access reports from the UE. The random access reports received from the UE may be relevant for one or more of the DUs (e.g., one or more of DUs 412, 414, 416, and/or 418).

Upon receiving the random access reports from the UE, CU 410 may forward the relevant information to the DUs as illustrated in FIG. 4 at operations 466, 468, 470, and 472. In an example implementation, if the UE sends different random access reports for different network types, CU 410 may send random access report associated with PLMN to DU 412 (at 466); CU 410 may send random access reports associated with SNPN and PNI-NPN to DU 414 (at 468); CU 410 may send random access reports associated with PNI-NPN to DU 416 (at 470); and/or CU 410 may send random access reports associated with PLMN, SNPN, and PNI-NPN to DU 418 (at 472). In another example implementation, if the UE sends a random access report with different network identifiers for the various network types, CU 410 may have to process the received random access report before the CU can send the relevant access reports (e.g., relevant portions of the received random access report, containers, etc.) to the DUs. In another example implementation, upon receiving the random access reports at 464, CU 410, at 474, may forward through an Xn interface random access reports that may be relevant for CU 420 to CU 420. For example, some random access attempts of the UE in the random access report may be related to cell(s) of CU 420 prior to the UE connecting to CU 410. In such scenarios, when CU 410 receives a random access report including random access attempts on cell(s) of another CU (e.g., CU 420), CU 410 may forward the relevant information of CU 420 to CU 420 via an Xn interface.

Thus, the UE may transmit random access reports in mixed network type configurations where the gNB may distinguish among random access failures associated with public and/or non-public networks and which may be further used to optimize the network.

In some implementations, the above described procedures may be triggered internally in the UE, for example, based on its capability (e.g., jointly supporting random access for public and private networks) and without configuration from the NG-RAN. However, the NG-RAN node that collects the random access report may be triggered by the core network or by an operations, administration, and management (OA&M) entity. In an example implementation, the network may trigger random access reporting towards NG-RAN with a job type set to random access report (e.g., jobType=RAReport), for example, as described earlier in reference to 330 of FIG. 3. The network configuration may identify RAN network entities that should be involved in the scheduled random access reporting. The network configuration may further set the scope where the random access reports should be collected by users, for example, random access-reporting area = PLMN IDs, SNPN, PNI-NPN, or a combination of those. In response to this configuration, the UE may simplify the random access reporting, for example, in terms of the association of the cell id with network identifiers.

In addition, in some implementations, for example, for each random access in a random access report, a UE may log timestamped information of each random access as following: i) for PLMN, UE may log the PLMN ID; ii) for SNPN, UE may log the PLMN ID and NID; iii) for PNI-NPN, UE may log the CAG ID and the CAG node on which random access is attempted in the random access report. The CAG-based UE random access reporting may allow the network to optimize random access resources per CAG ID and per cell using the CAG. Further, CAG-based UE random access reporting may allow the network to have information about the number of times a UE attempted random access procedure on a certain CAG, the number of UEs attempting access on a particular CAG, the success rate on a specific CAG (or the failure rate), etc. Furthermore, in the random access report, the UE may indicate the network type on which random access is attempted and the network type on which random access is finally successful. For example, the network can monitor whether random access is first attempted on a CAG cell before succeeding on a PLMN cell (e.g., by performing correlations using timestamps and an indicator of random access success) using this information. In addition, in an example implementation, the UE may log the trigger that caused the random access failure in the CAG.

In some implementation, for example, when a random access is successful, the UE may indicate to the network the availability of random access information of different network types (e.g., public-network or non-public network). The UE may indicate the availability of network types for which it has random access logs and for which network has advertised support through SIB information. The network may request the available UE random access reports and the UE may report only those random access reports requested by the network, which may be associated with random access to one or more of PLMN, SNPN, and PNI-NPN. This information may assist the network to optimize random access resources individually for public and non-public networks.

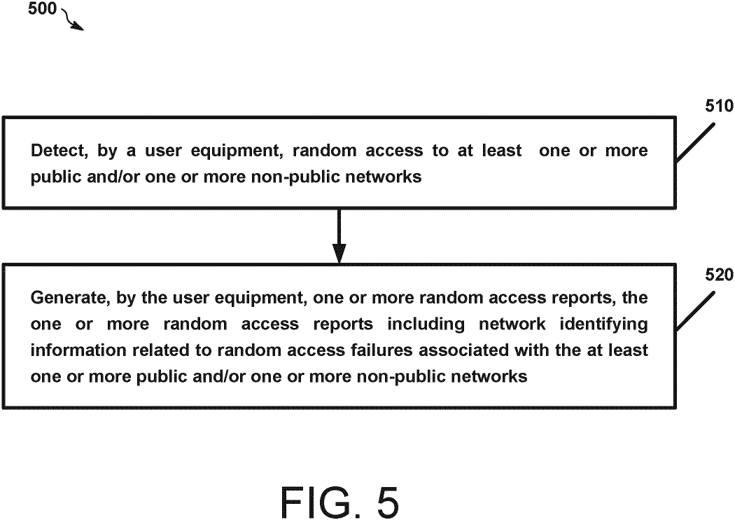

FIG. 5 is a flow chart 500 illustrating random access reporting in mixed network types, according to an additional example implementation.

In an example implementation, for example, at block 510, a user equipment, e.g., UE 302 of FIG. 3 or UE 402 of FIG. 4 may detect random access to at least one or more public and/or one or more non-public networks.

At 520, the UE may generate one or more random access reports. In some implementations for example, the one or more random access reports may include network identifying information related to random access failures associated with the at least one or more public and/or one or more non-public networks.

Thus, the gNB may receive random access reports in mixed network type configurations where the gNB may distinguish among random access failures associated with public and/or non-public networks and which may be further used to optimize the network.

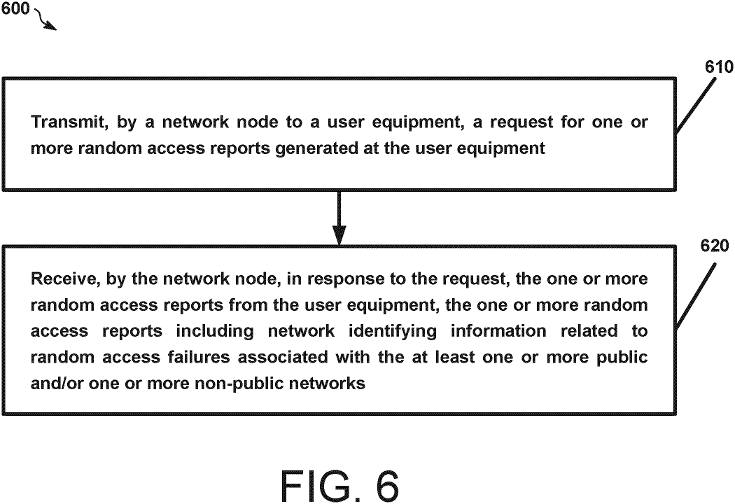

FIG. 6 is a flow chart 600 illustrating random access reporting in mixed network types, according to an additional example implementation.

In an example implementation, for example, at block 610, a gNB, e.g., gNB 310 of FIG. 3 or CU 410 of FIG. 4, may transmit a request for one or more random access reports generated to the gNB.

At block 620, the gNB may receive the one or more random access reports from the user equipment. In some implementations, for example, the one or more random access reports may include network identifying information related to random access failures associated with the at least one or more public and/or one or more non-public networks.

Thus, the gNB may receive random access reports in mixed network type configurations where the gNB may distinguish among random access failures associated with public and/or non-public networks and which may be further used to optimize the network.

Additional example implementations are described herein.

Example 1. A method of communications, comprising: detecting, by a user equipment, random access to at least one or more public and/or one or more non-public networks; and generating, by the user equipment, one or more random access reports, the one or more random access reports including network identifying information related to random access failures associated with the at least one or more public and/or one or more non-public networks.

Example 2. The method of Example 1, further comprising: transmitting the one or more random access reports to a network node.

Example 3. The method of any of Examples 1-2, wherein the one or more public networks include one or more public land mobile networks.

Example 4. The method of any of Examples 1-3, wherein the one or more non-public networks include one or more stand alone non-public networks and/or one or more public network integrated non-public networks.

Example 5. The method of any of Examples 1-4, wherein the generating includes generating at least a first random access report for the one or more non-public networks and at least a second random access report for the one or more public networks.

Example 6. The method of any of Examples 1-5, wherein the first random access report comprises a first network identifying information associated with the one or more non-public networks and the second random access report comprises a second network identifying information associated with the one or more public networks.

Example 7. The method of any of Examples 1-4, wherein the generating includes generating at least a first random access report for the one or more stand alone non-public networks, at least a second random access report for the one or more public network integrated non-public networks, and/or a third random access report for the one or more public networks.

Example 8. The method of any of Examples 1-4 and 7, wherein the first random access report comprises a first network identifying information associated with the one or more stand alone non-public networks, the second random access report comprises a second network identifying information associated with the one or more public network integrated non-public networks, and the third random access report comprises a third network identifying information associated with the one or more public networks.

Example 9. The method of any of Examples 1-4, wherein the generating includes generating a random access report, and wherein the random access report comprises: one or more random access related instances recorded for the one or more stand alone non-public networks and/or the one or more public network integrated non-public networks.

Example 10. The method of any of Examples 1-4, wherein the generating includes generating a random access report, and wherein the random access report comprises: one or more random access related instances recorded for the one or more stand alone non-public networks, the one or more public network integrated non-public networks, and/or the one or more public networks.

Example 11. The method of any of Examples 1-10, further comprising: receiving a request from the network node for the one or more random access reports generated at the user equipment, and wherein the transmitting the one or more random access reports is in response to the receiving the request.

Example 12. The method of any of Examples 1-11, wherein the request is received via a user equipment information request message from the network node, and wherein the request indicates information for one more network types.

Example 13. The method of any of Examples 1-12, wherein one or more reports for the one or more network types are transmitted via a user equipment information response message to the network node.

Example 14. The method of any of Examples 1-13, further comprising: receiving random access report configuration from the network node.

Example 15. The method of any of Examples 1-14, wherein the generating of the one or more random access reports is based at least on the random access report configuration.

Example 16. The method of any of Examples 1-15, wherein the network node is a gNB or a gNB centralized unit.

Example 17. A method of communications, comprising: transmitting, by a network node to a user equipment, a request for one or more random access reports generated at the user equipment; and receiving, by the network node, in response to the request, the one or more random access reports from the user equipment, the one or more random access reports including network identifying information related to random access failures associated with the at least one or more public and/or one or more non-public networks.

Example 18. The method of Example 17, wherein the one or more public networks include one or more public land mobile networks.

Example 19. The method of any of Examples 17-18, wherein the one or more non-public networks include one or more stand alone non-public networks and/or one or more public network integrated non-public networks.

Example 20. The method of any of Examples 17-19, wherein the receiving includes receiving at least a first random access report for the one or more public networks and/or at least a second random access report for the one or more non-public networks.

Example 21. The method of any of Examples 17-20, wherein the first random access report comprises a first network identifying information associated with the one or more public networks and/or the second random access report comprises a second network identifying information associated with the one or more non-public networks.

Example 22. The method of any of Examples 17-19, wherein the receiving comprises receiving a first random access report for the one or more public networks, a second random access report for the one or more stand alone non-public networks, and/or a third random access report for the one or more public network integrated non-public networks.

Example 23. The method of any of Examples 17-19 and 22, wherein the first access report comprises a first network identifying information associated with the one or more public networks, the second random access report comprises a second network identifying information associated with the one or more stand alone non-public networks, and/or the third random access report comprises a third network identifying information associated with the one or more public network integrated non-public networks.

Example 24. The method of any of Examples 17-19, wherein the receiving comprises receiving a random access report, and wherein the random access report comprises: one or more random access related instances recorded for the one or more stand alone non-public networks and/or the one or more public network integrated non-public networks, wherein the network node is configured with a plurality of network identifiers associated with the one or more public networks, the one or more stand alone non-public networks, and/or the one or more public network integrated non-public networks.

Example 25. The method of any of Examples 17-24, wherein the request is transmitted to the user equipment via a user equipment information request message.

Example 26. The method of any of Examples 17-25, wherein one or more reports are received from the user equipment via a user equipment information response message.

Example 27. The method of any of Examples 17-26, wherein the network node is a gNB or a gNB central unit.

Example 28. The method of any of Examples 17-27, wherein the network node is a gNB central unit, and further comprising: forwarding the one or more random access reports received from the user equipment to one or more corresponding distributed units of the gNB, and wherein the forwarding is based at least on configuration of the one or more distributed units.

Example 29. A method of communications, comprising: detecting, by a user equipment, random access to at least one or more public and one or more non-public networks; and generating, by the user equipment, one or more random access reports, the one or more random access reports including network identifying information related to random access failures associated with the at least one or more public and/or one or more non-public networks.

Example 30. An apparatus comprising means for performing the method of any of Examples 1-29.

Example 31. A non-transitory computer-readable storage medium comprising instructions stored thereon that, when executed by at least one processor, are configured to cause a computing system to perform the method of any of Examples 1-29.

Example 32. An apparatus comprising: at least one processor; and at least one memory including computer program code, the at least one memory and the computer program code configured to, with the at least one processor, cause the apparatus at least to perform the method of any of Examples 1-29.

Example 33. An apparatus comprising: at least one processor; and at least one memory including computer program code; the at least one memory and the computer program code configured to, with the at least one processor, cause the apparatus to: detect, by a user equipment, random access to at least one or more public and/or one or more non-public networks; and generate, by the user equipment, one or more random access reports, the one or more random access reports including network identifying information related to random access failures associated with the at least one or more public and/or one or more non-public networks.

Example 34. A non-transitory computer-readable storage medium comprising instructions stored thereon that, when executed by at least one processor, are configured to cause a computing system to perform detecting, by a user equipment, random access to at least one or more public and/or one or more non-public networks; and generating, by the user equipment, one or more random access reports, the one or more random access reports including network identifying information related to random access failures associated with the at least one or more public and/or one or more non-public networks.

Example 35. An apparatus comprising: at least one processor; and at least one memory including computer program code; the at least one memory and the computer program code configured to, with the at least one processor, cause the apparatus to: transmit, by a network node to a user equipment, a request for one or more random access reports generated at the user equipment; and receive, by the network node, in response to the request, the one or more random access reports from the user equipment, the one or more random access reports including network identifying information related to random access failures associated with the at least one or more public and/or one or more non-public networks.

Example 36. A non-transitory computer-readable storage medium comprising instructions stored thereon that, when executed by at least one processor, are configured to cause a computing system to perform: transmitting, by a network node to a user equipment, a request for one or more random access reports generated at the user equipment; and receiving, by the network node, in response to the request, the one or more random access reports from the user equipment, the one or more random access reports including network identifying information related to random access failures associated with the at least one or more public and/or one or more non-public networks.

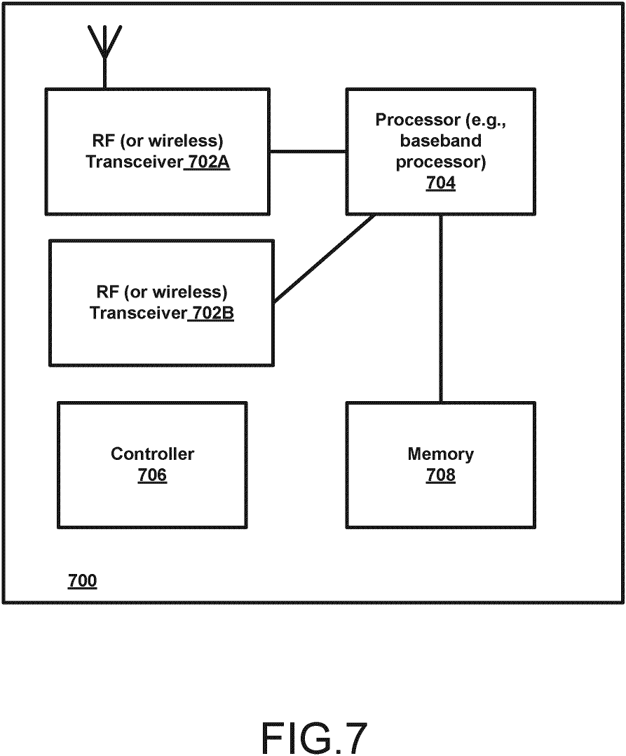

FIG. 7 is a block diagram of a wireless station (e.g., user equipment (UE)/user device or AP/gNB/MgNB/SgNB) 700 according to an example implementation. The wireless station 700 may include, for example, one or more RF (radio frequency) or wireless transceivers 702A, 702B, where each wireless transceiver includes a transmitter to transmit signals and a receiver to receive signals. The wireless station also includes a processor or control unit/entity (controller) 704/706 to execute instructions or software and control transmission and receptions of signals, and a memory 708 to store data and/or instructions.

Processor 704 may also make decisions or determinations, generate frames, packets or messages for transmission, decode received frames or messages for further processing, and other tasks or functions described herein. Processor 704, which may be a baseband processor, for example, may generate messages, packets, frames or other signals for transmission via wireless transceiver 702 (702A or 702B). Processor 704 may control transmission of signals or messages over a wireless network, and may control the reception of signals or messages, etc., via a wireless network (e.g., after being down-converted by wireless transceiver 702, for example). Processor 704 may be programmable and capable of executing software or other instructions stored in memory or on other computer media to perform the various tasks and functions described above, such as one or more of the tasks or methods described above. Processor 704 may be (or may include), for example, hardware, programmable logic, a programmable processor that executes software or firmware, and/or any combination of these. Using other terminology, processor 704 and transceiver 702 together may be considered as a wireless transmitter/receiver system, for example.

In addition, referring to FIG. 7, a controller 706 (or processor 704) may execute software and instructions, and may provide overall control for the station 700, and may provide control for other systems not shown in FIG. 7, such as controlling input/output devices (e.g., display, keypad), and/or may execute software for one or more applications that may be provided on wireless station 700, such as, for example, an email program, audio/video applications, a word processor, a Voice over IP application, or other application or software. Moreover, a storage medium may be provided that includes stored instructions, which when executed by a controller or processor may result in the processor 704, or other controller or processor, performing one or more of the functions or tasks described above.

According to another example implementation, RF or wireless transceiver(s) 702A/702B may receive signals or data and/or transmit or send signals or data. Processor 704 (and possibly transceivers 702A/702B) may control the RF or wireless transceiver 702A or 702B to receive, send, broadcast or transmit signals or data.

The aspects are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input – multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers,...) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

1-32. (canceled)

33. An apparatus comprising:
at least one processor; and
at least one memory including computer program code;
the at least one memory and the computer program code configured to, with the at least one processor, cause the apparatus at least to:
detect, by a user equipment, random access to at least one or more public and/or one or more non-public networks; and
generate, by the user equipment, one or more random access reports, the one or more random access reports including network identifying information related to random access failures associated with the at least one or more public and/or one or more non-public networks.

34. The apparatus of claim 33, wherein the computer program code and the at least one processor are configured to further cause the apparatus to:
transmit, the one or more random access reports to a network node.

35. The apparatus of claim 33, wherein the one or more public networks include one or more public land mobile networks.

36. The apparatus of claim 33, wherein the one or more non-public networks include one or more stand alone non-public networks and/or one or more public network integrated non-public networks.

37. The apparatus of claim 33, wherein the computer program code and the at least one processor configured to cause the apparatus to generate comprises the computer program code and the at least one processor configured to cause the apparatus to:
generate at least a first random access report for the one or more non-public networks and at least a second random access report for the one or more public networks.

38. The apparatus of claim 37, wherein the first random access report comprises a first network identifying information associated with the one or more non-public networks and the second random access report comprises a second network identifying information associated with the one or more public networks.

39. The apparatus of claim 33, wherein the computer program code and the at least one processor configured to cause the apparatus to generate comprises the computer program code and the at least one processor configured to cause the apparatus to:
generate at least a first random access report for the one or more stand alone non-public networks, at least a second random access report for the one or more public network integrated non-public networks, and/or a third random access report for the one or more public networks.

40. The apparatus of claim 37, wherein the first random access report comprises a first network identifying information associated with the one or more stand alone non-public networks, the second random access report comprises a second network identifying information associated with the one or more public network integrated non-public networks, and the third random access report comprises a third network identifying information associated with the one or more public networks.

41. The apparatus of claim 33 wherein the computer program code and the at least one processor configured to cause the apparatus to generate comprises the computer program code and the at least one processor configured to cause the apparatus to:
generate a random access report, wherein the random access report comprises:
one or more random access related instances recorded for the one or more stand alone non-public networks and/or the one or more public network integrated non-public networks.

42. The apparatus of claim 33, wherein the computer program code and the at least one processor configured to cause the apparatus to generate comprises the computer program code and the at least one processor configured to cause the apparatus to:
generate a random access report, wherein the random access report comprises:
one or more random access related instances recorded for the one or more stand alone non-public networks, the one or more public network integrated non-public networks, and/or the one or more public networks.

43. The apparatus of claim 33, wherein the computer program code and the at least one processor are further configured to cause the apparatus to:
receive a request from the network node for the one or more random access reports generated at the user equipment; and
wherein the computer program code and the at least one processor configured to cause the apparatus to transmit the one or more random access reports comprises the computer program code and the at least one processor configured to cause the apparatus to transmit the one or more random access reports in response to receiving the request.

44. The apparatus of claim 33, wherein the request is received via a user equipment information request message from the network node, and wherein the request indicates information for one more network types.

45. The apparatus of claim 33, wherein one or more reports for the one or more network types are transmitted via a user equipment information response message to the network node.

46. The apparatus of claim 33, wherein the computer program code and the at least one processor are further configured to cause the apparatus to:
receive a random access report configuration from the network node.

47. The apparatus of claim 46, wherein the computer program code and the at least one processor configured to cause the apparatus to generate comprises the computer program code and the at least one processor configured to cause the apparatus to:
generate the one or more random access reports based at least on the random access report configuration.

48. The apparatus of claim 33, wherein the network node is a gNB or a gNB centralized unit.

49. A method of communications, comprising:
detecting, by a user equipment, random access to at least one or more public and/or one or more non-public networks; and
generating, by the user equipment, one or more random access reports, the one or more random access reports including network identifying information related to random access failures associated with the at least one or more public and/or one or more non-public networks.

50. An apparatus comprising:
at least one processor; and
at least one memory including computer program code;
the at least one memory and the computer program code configured to, with the at least one processor, cause the apparatus at least to:
transmit, by a network node to a user equipment, a request for one or more random access reports generated at the user equipment; and
receive, by the network node, in response to the request, the one or more random access reports from the user equipment, the one or more random access reports including network identifying information related to random access failures associated with the at least one or more public and/or one or more non-public networks.

51. The apparatus of claim 50, wherein the computer program code and the at least one processor configured to cause the apparatus to receive comprises the computer program code and the at least one processor configured to cause the apparatus to:
receive at least a first random access report for the one or more public networks and/or at least a second random access report for the one or more non-public networks.

52. The apparatus of claim 50, wherein the first random access report comprises a first network identifying information associated with the one or more public networks and/or the second random access report comprises a second network identifying information associated with the one or more non-public networks.
